(19) United States
(12) Patent Application Publication
(10) Pub. No.: US 2025/0385441 A1
(43) Pub. Date: Dec. 18, 2025

(54) APPARATUS FOR EMULATING A WIRELESS MESH NETWORK

(71) Applicant: Landis+Gyr Technology, Inc., Alpharetta, GA (US)

(72) Inventor: Justin MATTHEWS, Alpharetta, GA (US)

(21) Appl. No.: 19/108,882

(22) PCT Filed: Sep. 7, 2023
(86) PCT No.: PCT/US2023/073687

§ 371 Date: Mar. 5, 2025

(30) Foreign Application Priority Data
Sep. 9, 2022 (GB) 2213236.9

(51) Int. Cl. H01Q 21/06; H01Q 1/22; H01Q 9/30; H04B 17/391

(52) U.S. Cl. CPC H01Q 21/067; H01Q 1/2233; H01Q 9/30; H04B 17/3912

(57) ABSTRACT

An apparatus (100, 1100, 1200a-g) for emulating a wireless mesh network is disclosed. The apparatus comprises a plurality of monopole antennas (105, 1105) and at least one connector (110, 1100) for conductively coupling the plurality of monopole antennas to at least one communications device (220). Each monopole antenna is disposed within a near-field region of a neighboring monopole antenna when the monopole antennas are used to emulate a wireless mesh network operating within a communications frequency range of 3500 MHz to 300 MHz. A system (400, 500) for emulating a wireless mesh network and an associated method of emulating a wireless mesh network are also disclosed.

### FIELD OF INVENTION

The disclosure is in the field of apparatuses, systems and methods of emulating a wireless mesh network, and in particular a wireless mesh network of metering devices, such as smart meters.

### BACKGROUND TO INVENTION

Metering devices may be deployed at businesses, homes, and other premises for measuring consumption of resources, such as electricity, water, and gas.

While some metering devices may provide only basic metering functions, other metering devices, known in the art as “smart meters”, may provide more advanced functionality, such as control and communications functionality.

In an example, some metering devices may be configured to communicate information relating to consumption of resources. In another example, some metering devices may be configured to receive information such as billing information and control signals, such as service disconnect control signals or the like. In examples, transmission of information relating to consumption of metered resources may simplify automated billing, reduce operational costs, and may enable advanced analytics of resource consumption.

While in some examples a metering device may communicate directly with a router or gateway device, in other examples a wireless mesh network may be formed from multiple metering devices, wherein each metering device operates as an interconnected node within the wireless mesh network.

When implemented in a wireless mesh network, a metering device operating as a network node may relay messages to or from a gateway device or router. In an example, messages may be routed along a path by hopping from node to node, e.g. from metering device to metering device until said messages reaches a target destination, e.g. the gateway/router or a target metering device.

Various routing protocols may be implemented in a wireless mesh network to ensure availability of sufficient data routing paths within the mesh network at any given time. In some examples of wireless mesh networks, paths within the network may self-form and/or self-heal, e.g. reconfigure around broken paths. Such self-healing may allow a routing-based network to operate when a node breaks down or when a connection between nodes becomes unreliable.

In use, smart metering devices within a wireless mesh network may constantly communicate with each other to, for example, exchange messages or transmit data. In examples, different nodes within the network may have different hardware and software configurations and thus may support different communication modes. In addition, each node may support multiple communication modes.

Throughput and reliability are important issues for communications in such wireless mesh networks. For example, a throughput may be impacted if a node has a pending communication but is unable to access a communications channel. Other nodes may already be using the channel for communication or the channel may be otherwise unavailable. Furthermore, variable environmental conditions and in-band interference can result in communication failures in a wireless mesh network.

It is highly desirable to test and validate correct operation or metering devices for forming a wireless mesh network prior to field deployment of such metering devices. However, due to practical limitations, such testing and validation may be complex, costly and of limited accuracy.

In known prior art examples, arrays of metering devices may be setup over a relatively large area to emulate a deployment of metering devices in a particular setting, such as a rural or urban deployment. Such a validation setup may be complex and incur significant cost, yet may provide results of limited accuracy. In an example, to attempt to emulate path losses in a wireless mesh network in a desired configuration such as a rural or urban based wireless mesh network, a transmission power and/or reception sensitivity of each metering device in a network may be adapted, and/or an antenna of each metering device may be adjusted.

It is therefore desirable to provide a relatively low-complexity and cost-effective means to emulate a deployment of metering devices forming a wireless mesh network. In particular, it is desirable that such means are capable of emulating path losses between metering devices that may representative of real-life scenarios, thereby increasing a level of confidence in validation results.

It is therefore an aim of at least one embodiment of at least one aspect of the present disclosure to obviate or at least mitigate at least one of the above identified shortcomings of the prior art.

### SUMMARY OF INVENTION

The present disclosure is in the field of apparatuses, systems and methods of emulating a wireless mesh network. According to a first aspect of the disclosure, there is provided an apparatus for emulating a wireless mesh network, the apparatus. The apparatus comprises a plurality of monopole antennas and at least one connector for conductively coupling the plurality of monopole antennas to at least one communications device. Each monopole antenna is disposed within a near-field region of a neighboring monopole antenna when the monopole antennas are used to emulate a wireless mesh network operating within a communications frequency range of 3500 MHz to 300 MHz.

Advantageously, such an apparatus may provide a low-cost and relatively compact means to emulate a wireless mesh network. That is, a length of the monopole antennas and/or spacing between the monopole antennas that enables emulation of a wireless mesh network operating within a communications frequency range of 3500 MHz to 300 MHz may be sufficiently small that a complete wireless mesh network may be emulated with an extremely small apparatus. As an example, a wireless mesh network comprising approximately one thousand monopole antennas may be emulated using an apparatus having dimensions in the range of tens of centimeters, compared to tens or hundreds of meters as may be required by the prior art emulation schemes described above.

Advantageously, a communications frequency range of 3500 MHz to 300 MHz encompasses a majority of frequencies currently used for cellular communications and ISM radio bands currently used for smart metering devices.

The communications frequency range may be from 1000 MHz to 400 MHz. The communications frequency range may be from 915 MHz to 860 MHz.

Advantageously, such a communications range encompasses International Telecommunications Union (ITU) Region 2 frequency allocation, as may be used by smart metering devices.

Each monopole antenna may comprise a length substantially corresponding to a length of a quarter-wave monopole for a frequency within the communications frequency range.

Advantageously, a quarter wave monopole may provide sufficient transmission and reception performance combined with an omnidirectional radiation pattern.

It will be appreciated that a length of each monopole antenna may not correspond to exactly a quarter wave monopole, and may be slightly longer or shorter than a quarter wavelength of a transmitted/received signal.

Furthermore, in examples wherein the apparatus is designed for emulating a range of frequencies, a length of each monopole antenna may be generally in the region of a quarter of a wavelength, e.g. between approximately 7 and 9 centimeters for an apparatus for emulating communications frequency ranges of 915 MHz and 860 MHz.

In other examples, the monopole antennas may comprise lengths substantially corresponding to 0.625 of a wavelength, which may advantageously radiate a maximum amount of power in a horizontal direction towards a neighboring monopole antenna.

The near-field of each monopole antenna may be a region within a radius r«λ, wherein λ is a wavelength of radiation within the communications frequency range.

The near-field region may be a reactive near field region.

Advantageously, by operating in a reactive near field region, a path loss between each monopole antenna may be maximized, thereby enabling an emulation of path losses incurred over a large distance through air using a relatively small spacing between monopole antennas.

The plurality of monopole antennas may be arranged in an array. The plurality of monopole antennas may be arranged in an offset grid. The plurality of monopole antennas may be arranged in concentric patterns.

The plurality of monopole antennas may be arranged such that each monopole antenna extends longitudinally in a direction parallel to a direction in which a neighboring monopole antenna extends longitudinally.

That is, in some examples the monopole antennas may be essentially identical to one another.

For a wireless signal within the communications frequency range, a path attenuation between a first monopole antenna disposed in a central region of the plurality of monopole antennas and a second monopole antenna of the plurality of monopole antennas may be configured to be between 90 dB and 160 dB. In other examples, the path attenuation may be between 100 dB and 150 dB

The path attenuation may be determined by selection of a length of each monopole antenna. The path attenuation may be determined by selection of a spacing between each monopole antenna. The path attenuation may be determined by selection of a magnitude of an impedance coupled to each monopole antenna. The path attenuation may be determined by selection of a dielectric material disposed between and extending around each monopole antenna.

Advantageously, by selecting an appropriate path attenuation, path losses representative of real-life scenarios may be replicated, as described in more detail below. In particular, a path attenuation of between 90 dB and 160 dB may be suitable for representing basis transmission losses in a suburban environment, as defined by the ITU-R P.1411-19 site-general model.

That is, the disclosed apparatus may be capable of operating as an ‘air-emulation’ device, e.g. for emulating losses over the air in various environments, such as rural, suburban and urban.

The apparatus may comprise a terminating impedance coupled to each monopole antenna.

Advantageously, a terminating impedance may help avoid unwanted resonances incurring in the monopole antennas.

Furthermore, a magnitude of the terminating impedance may be selected to adjust a transmission power and/or reception sensitivity of the monopole antennas.

The terminating impedance of at least one of the plurality of monopole antennas may be different from, and/or variable relative to, the terminating impedance of at least one other of the plurality of monopole antennas.

Advantageously, a particular monopole antenna may be configured to emulate a pole-mounted device, such as a gateway or router. In practice, such a device may have an effective higher transmission power and/or reception sensitivity due to its placement above ground level and distant from immediate obstructions and sources of interference. By adjusting a terminating impedance of at least one of the plurality of monopole antennas, e.g. reducing an attenuation, and effective transmission power and reception sensitivity of the at least one of the plurality of monopole antennas may be increased, thereby emulating a pole mounted device relative to the other monopole antennas.

The apparatus may comprise a substrate. The plurality of monopole antennas extend from a first side of the substrate. The at least one connector may be provided on a second side of the substrate. The substrate may comprise a ground plane, e.g. an electrically conductive ground plane.

The substrate may be a printed circuit board.

The apparatus may comprise a/the dielectric material disposed between and extending around each monopole antenna.

The dielectric material may provide structural support to the apparatus, and may prevent damage to the monopole antennas in use.

The dielectric material may increase an attenuation of RF transmission, e.g. increase an effective path loss, between monopole antennas of the apparatus. Advantageously, this may allow a relatively small and compact apparatus to emulate equivalent path losses of relatively large distances over the air.

According to a second aspect of the disclosure, there is provided a system for emulating a wireless mesh network. The system comprises an apparatus according to the first aspect. The system also comprises the at least one communications device conductively coupled to each monopole antenna by the at least one connector. The at least one communications device may be configured to transmit and/or receive a wireless signal within the communications frequency range using each monopole antenna.

The at least one communications device may be configured to operate with data transmission and reception corresponding to use as a smart metering device.

The at least one communications device may comprise a plurality of communications devices. In an example, a communications device may be coupled to each monopole antenna.

The at least one communications device may be configured to form a wireless mesh network using the plurality of monopole antennas.

The system may comprise a plurality of apparatuses according to the first aspect. Each apparatus may be disposed immediately adjacent another apparatus of the plurality of apparatuses.

Advantageously, a plurality of apparatuses may be used to increase a quantity of monopole antennas in the wireless mesh network, enabling emulation of deployment of a large network of metering devices.

Advantageously, a plurality of apparatuses may be used to emulate different mesh fringe shapes, by placing each apparatus relative to each other apparatus in a configuration providing, at least approximately, a desired fringe shape.

The at least one communications device may comprises at least one modem. The system may comprising one or more processors configured to control the at least one communications device to emulate a wireless mesh network between the monopole antennas.

A communications device coupled to one of the monopole antennas may be configured to operate as a gateway device.

According to a third aspect of the disclosure, there is provided a method of emulating a wireless mesh network. The method comprises conductively coupling a plurality of monopole antennas to at least one communications device, wherein each monopole antenna is disposed within a near-field region of a neighboring monopole antenna when the monopole antennas are used to emulate a wireless mesh network operating within a communications frequency range of 3500 MHz to 300 MHz.

The method also comprises configuring the at least one communications device to form a wireless mesh network between the plurality of monopole antennas by transmitting and/or receiving signals within the communications frequency range.

The method may comprise a step of configuring a communications device coupled to one of the monopole antennas to operate as a gateway device to the mesh network. The method may comprising a step of increasing a transmission power and/or reception sensitivity of the monopole antenna operating as a gateway device relative to the other monopole antennas of the plurality of monopole antennas.

The above summary is intended to be merely exemplary and non-limiting. The disclosure includes one or more corresponding aspects, embodiments or features in isolation or in various combinations whether or not specifically stated (including claimed) in that combination or in isolation. It should be understood that features defined above in accordance with any aspect of the present disclosure or below relating to any specific embodiment of the disclosure may be utilized, either alone or in combination with any other defined feature, in any other aspect or embodiment or to form a further aspect or embodiment of the disclosure.

### BRIEF DESCRIPTION OF DRAWINGS

These and other aspects of the present disclosure will now be described, by way of example only, with reference to the accompanying drawings, wherein:

FIG. 1a depicts a cross-sectional view of an apparatus for emulating a wireless mesh network, according to an embodiment of the disclosure;

FIG. 1b depicts an alternative view of the apparatus of FIG. 1a;

FIG. 1c depicts alternative arrangements of the monopole antennas in an apparatus for emulating a wireless mesh network, according to embodiments of the disclosure;

FIG. 2a depicts a plan view of an example of a first further apparatus comprising a plurality of communications devices, according to an embodiment of the disclosure;

FIG. 2b depicts an alternative view of the first further apparatus of FIG. 2a;

FIG. 3a depicts a plan view of an example of a second further apparatus for coupling to a plurality of the first further apparatuses, according to an embodiment of the disclosure;

FIG. 3b depicts an alternative view of the second further apparatus of FIG. 3a;

FIG. 4 depicts an example system for emulating a wireless mesh network, according to an embodiment of the disclosure;

FIG. 5 depicts an example system, comprising a plurality of the systems of FIG. 4, for emulating a wireless mesh network, according to an embodiment of the disclosure;

FIG. 6 is a graph of a propagation model depicting probabilities of transmission path losses versus distance, based on a Site General Model in an urban environment;

FIG. 7a-b are graphs depicting a number of metering devices in a geographic uniform distribution against an expected path loss;

FIG. 8a depicts interference ranges for a selection of PHY modes supported in a Wi-SUN 1.1 network;

FIG. 8b depicts communications ranges for the selection of PHY modes supported in the Wi-SUN 1.1 network;

FIG. 9a depicts an example configuration of an apparatus for emulating a wireless mesh network according to an embodiment of the disclosure;

FIG. 9b a simulated resultant path loss distribution at 915 MHZ, using the model of FIG. 9a;

FIG. 10 depicts path losses across another example apparatus for emulating a wireless mesh network;

FIG. 11a depicts an example of injecting a gateway signal into an apparatus for emulating a wireless mesh network;

FIG. 11b depicts a further example of injecting a gateway signal into an apparatus for emulating a wireless mesh network;

FIG. 12a depicts a first arrangement comprising a plurality of apparatuses for emulating a wireless mesh network; and

FIG. 12b depicts a second arrangement comprising a plurality of apparatuses for emulating a wireless mesh network.

### DETAILED DESCRIPTION OF DRAWINGS

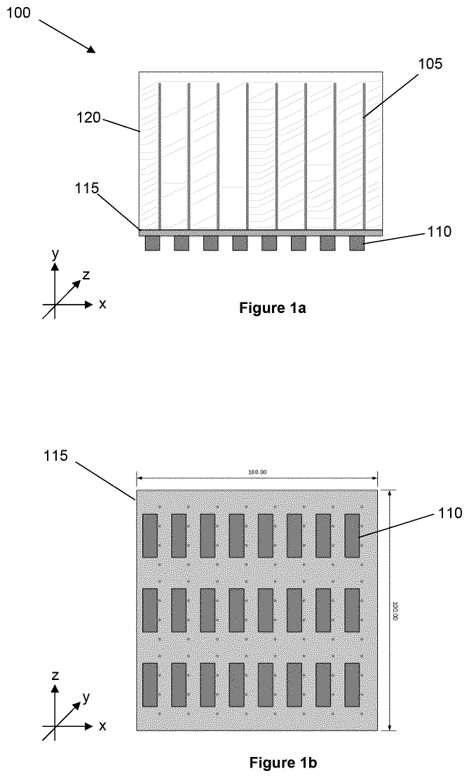

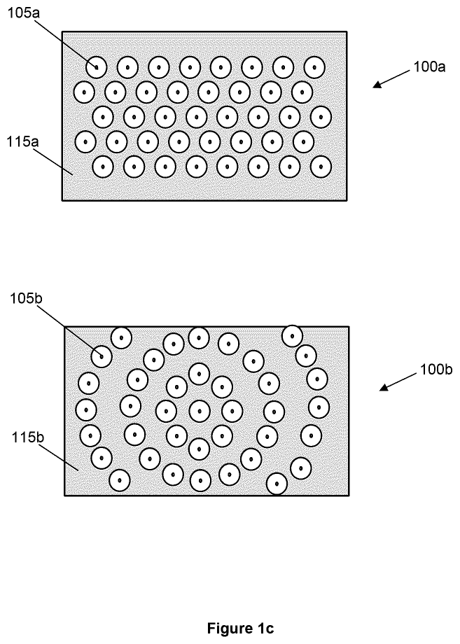

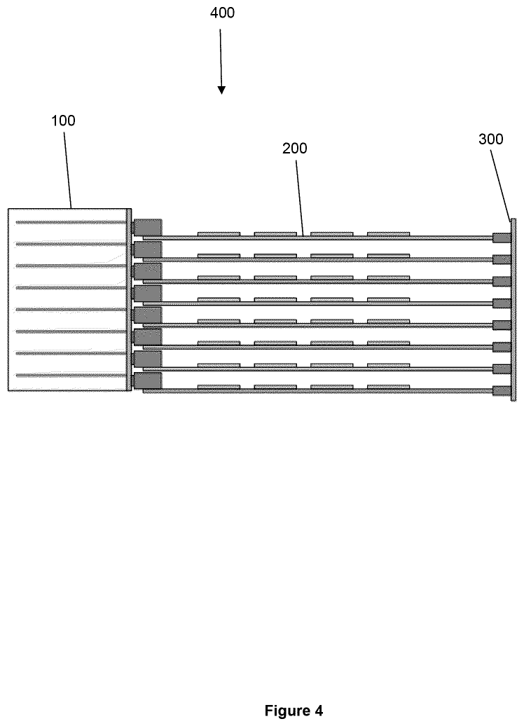

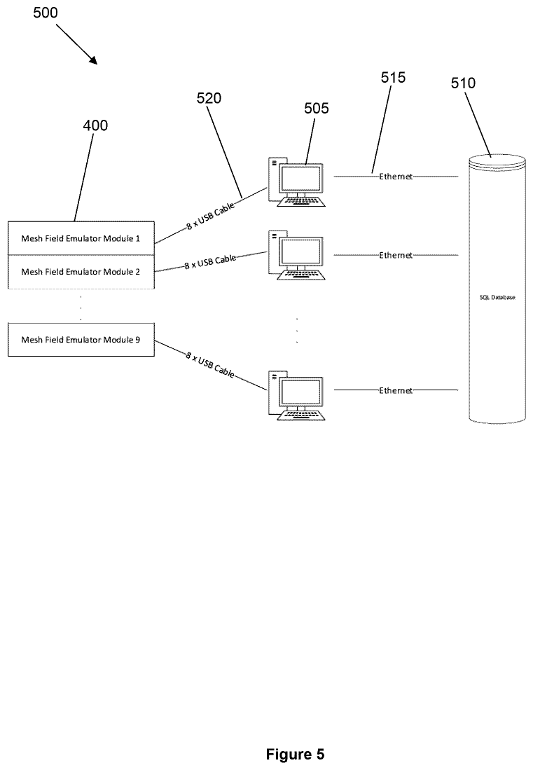

FIG. 1a depicts a cross-sectional view of an apparatus 100 for emulating a wireless mesh network. The apparatus 100 may provide a component of a system 400, 500 for emulating the wireless mesh network, as described in more detail below with reference to FIGS. 4 and 5.

The apparatus 100 comprises a plurality of monopole antennas 105. In the example cross-section, only eight monopole antennas 105 are depicted in a row. In other examples falling within the scope of the disclosure, substantially more than eight monopole antennas 105 may be implemented in each row. Furthermore, in the example apparatus 100 the monopole antennas 105 are arranged as an 8×12 grid, as represented by the dots depicted in FIG. 1b which depicts an alternative view of the apparatus 100 of FIG. 1a. In other example apparatus, other grid arrangements may be implemented.

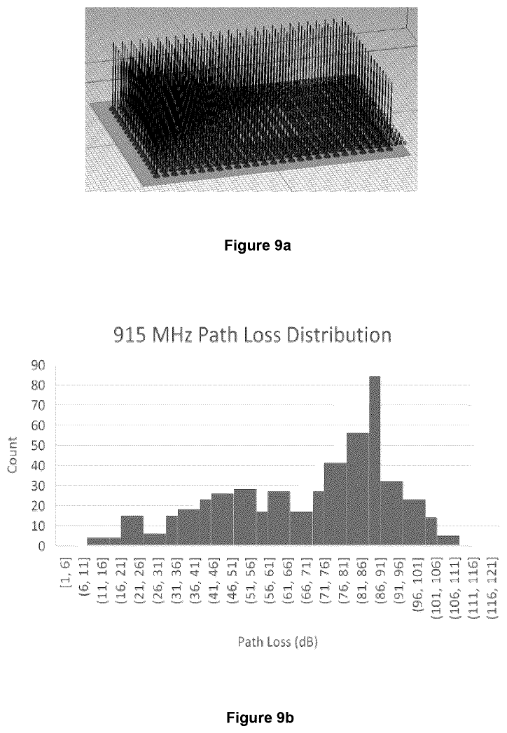

Although the example apparatus 100 comprise a total of ninety six monopole antennas, it will be understood that this is for purposes of example only and in other embodiments substantially fewer than or greater than ninety six monopole antennas may be implemented. For example, FIG. 9a described below depicts a further embodiment comprising in the region of 486 monopole antennas arranged as a 27×18 grid.

Each monopole antenna 105 comprises a conductive material, and is generally elongate in shape. For example, each monopole antenna 105 may be implemented as a pin or rod. A cross-sectional shape of each monopole antenna 105 may be circular, or may have other form.

In a simplified manufacturing technique, the monopole antennas 105 may be formed using one or more strips of through-hole mount Printed Circuit Board (PCB) headers, wherein each header may have a non-circular cross-section, such as a square cross section.

The plurality of monopole antennas 105 are arranged such that each monopole antenna 105 extends longitudinally in a direction parallel to a direction in which a neighboring monopole antenna 105 extends longitudinally. That is, the example apparatus 100 of FIG. 1 comprises an array of monopole antennas 105 arranged in parallel to one another.

The apparatus 100 comprises a substrate 115. The plurality of monopole antennas 105 are mounted on the substrate 115. In an example, the substrate 115 is a PCB.

The apparatus 100 also comprises a plurality of connectors 110. The connectors 110 are suitable for conductively coupling the plurality of monopole antennas 105 to at least one communications device, as described below. An array of connectors 110 can be seen in FIG. 1b, which depicts an alternative view of the apparatus 100.

As shown in FIG. 1a, the plurality of monopole antennas 105 may extend from a first side of the substrate 115, and the connectors 110 may be provided on a second side of the substrate 115. In other examples, one or more connectors 110 may alternatively and/or additionally be provided on a same side of the substrate 115 as the monopole antennas 105, e.g. on a portion of the substrate 115 extending away from the plurality of monopole antennas 105.

The substrate may comprise a ground plane (not depicted). The ground plane may be formed from an electrically conductive layer on or within the substrate 115. The ground plane may extend around a base of each monopole antenna 105.

Although 24 connectors 110 are depicted, it will be appreciated that other amounts of connects may be implemented. In some embodiments, as few as a single connector may be implemented.

In some examples, the connectors 110 may be configured to provide a terminating impedance to each monopole antenna. Advantageously, an impedance coupled to each monopole antenna 105 may help prevent any unwanted resonances incurring within the monopole antennas in use.

The substrate 115 may comprise a multi-layer PCB, wherein routing from each monopole antenna 105 to a respective connector 110 may be provided in one or more conductive layers of the substrate 115.

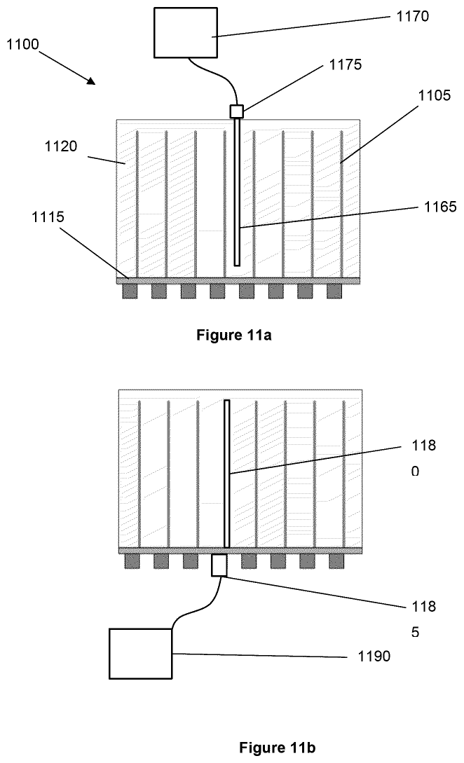

In some embodiments, at least one of the connectors 110, and preferably a connector 110 coupled to a monopole antenna 105 disposed substantially towards a center of the plurality of monopole antennas 105, may be implemented as a coaxial connector. Such a coaxial connector may be implemented as an SMA connector, for injecting a gateway signal. Injection of a gateway signal is discussed in more detail below with reference to FIGS. 11a and 11b.

The example apparatus 100 also comprises a dielectric material 120 disposed between and extending around each monopole antenna 105. The dielectric material 120 may provide structural support to the apparatus 100, and may prevent damage to the monopole antennas 105 in use.

Furthermore, the dielectric material 120 may also increase an attenuation of RF transmissions between monopole antennas 105 of the apparatus 100, as described in more detail below.

The dielectric material 120 may comprise, for example, wood, a Polycarbonate, an Acrylic or resin, or the like. In an embodiment, the dielectric material 120 may comprise a polyamide-based material, e.g. Nylon, which may be suitable for high temperature testing of the apparatus 100.

Each monopole antenna 105 is disposed within a near-field region of a neighboring monopole antenna 105 when the monopole antennas 105 are used to emulate a wireless mesh network operating within a communications frequency range of 3500 MHz to 300 MHz. That is, a length of each monopole antenna 105 and a spacing between the monopole antennas 105 is selected such that when used to emulate a wireless mesh network operating within the communications frequency range, each monopole antenna 105 is disposed within a near-field region of a neighboring monopole antenna 105.

In other examples embodiments, a spacing between monopole antennas 105 and a length of the monopole antennas may be selected such that each monopole antenna 105 is disposed within a near-field region of a neighboring monopole antenna 105 when the monopole antennas 105 are used to emulate a wireless mesh network operating within a communications frequency range of 1000 MHz to 400 MH, or from 915 MHz to 860 MHz. Preferably, each monopole antenna 110 may comprise a length approximately corresponding to a length of a quarter-wave monopole for a frequency within the communications frequency range.

Although the example apparatus 100 comprises monopole antennas 105 arranged in a regular gird, other arrangements of monopole antennas 105 also fall within the scope of the disclosure. For example, FIG. 1c depicts alternative arrangements of monopole antennas. In a first alternative apparatus 100a, a plurality of monopole antennas 105a are arranged in an offset grid pattern on a substrate 115a. In a second alternative apparatus 100b, a plurality of monopole antennas 105b are arranged in concentric patterns on a substrate 115b.

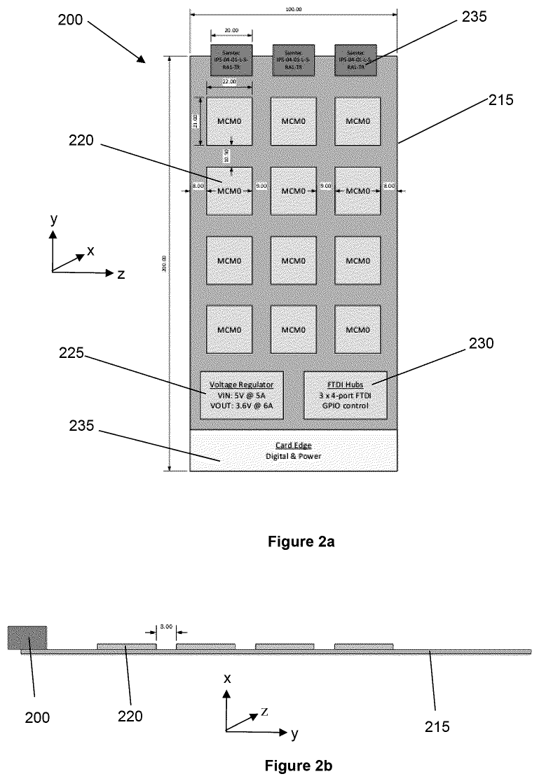

FIG. 2a depicts a plan view of an example of a first further apparatus 200 comprising a plurality of communications devices 220 for conductively coupling to each monopole antenna by the connectors 110. FIG. 2b depicts an alternative view of the first further apparatus 200.

The further apparatus comprises a substrate 215, e.g. a PCB. A plurality of communications devices 220 are mounted on the substrate 215. Each communications device 220 comprises and/or or may be configured to function as at least one modem. Also depicted, for purposes of example only, is: power supply circuitry 225 comprising voltage regulation, for providing a power supply to the plurality of communications devices 220; and additional control circuitry 230.

An end portion 235 of the substrate 215 comprises contacts (not shown) for routing signals and power supplies to the power supply circuitry 220, the additional control circuitry 225 and/or one or more of the plurality of communications devices 220.

The first further apparatus 200 also comprise a plurality of connectors 210. The connectors 210 are suitable for coupling with the connectors 110 of the apparatus 100, thereby conductively coupling the plurality of communications devices 220 to the plurality of monopole antennas 105.

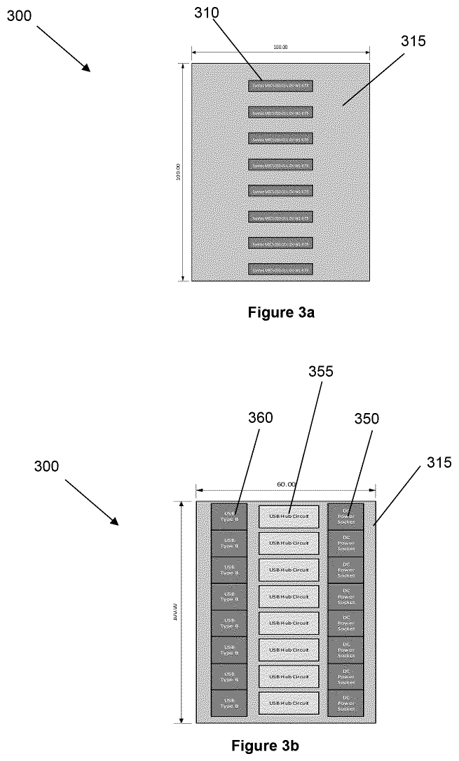

FIG. 3a depicts a plan view of an example of a second further apparatus 300 for coupling to a plurality of the first further apparatuses 200, according to an embodiment of the disclosure.

The example second further apparatus 300 comprises a substrate 315 and a plurality of connectors 310 provided on a first side of the substrate 315, as depicted in FIG. 3a. Each connector 310 is configured to receive a first further apparatus 200, e.g. the end portion 235 of the substrate 215 of the first further apparatus 200.

In the example, the second further apparatus 300 is configured to be coupled to eight first further apparatuses 200.

On a second side of the substrate 315 depicted in FIG. 3b, a plurality of power supply connectors 350, e.g. DC power sockets, are provided. Each power supply connector 350 is for providing a power supply to a respective first further apparatus 200 coupled to a respective connector 310. Also depicted is Universal Serial Bus (USB) driver circuitry 355 and a USB connector 360 associated with each respective connector 310.

FIG. 4 depicts an example system 400 for emulating a wireless mesh network, according to an embodiment of the disclosure. The example system 400 comprises an apparatuses 100, as depicted in FIGS. 1a-c above.

The example system 400 also comprises a plurality of first further apparatuses, as depicted in FIGS. 2a and 2b above. Each first further apparatus 200 is coupled to the apparatus 100. That is, in the example each group of connectors 110 of the apparatus 100 is coupled to a respective connector 210 of a respective first further apparatus 200.

As such, the system 400 comprises a plurality of communications devices 220, wherein at least one communications device 200 is conductively coupled to each monopole antenna 105 by respective connectors 110, 210. The communications devices 220 are configured to transmit and/or receive wireless signals within the communications frequency range using each monopole antenna 105.

The example system 400 also comprises a second further apparatus 300, as depicted in FIGS. 3a-b. Each first further apparatus 200 is coupled to the second further apparatus 300 by respective connectors 210, 310.

FIG. 5 depicts an example system 500, comprising a plurality of the systems 400, in use to emulate a wireless mesh network, according to an embodiment of the disclosure.

The example system 500 comprises a plurality of the systems 400 of FIG. 4, wherein each system 400 is coupled to a respective processor 505 by eight USB cables 520.

Finally, each processor 505 is coupled to a database 510. For purposes of example only, connectivity between each processor 505 and the database 510 is by Ethernet connections 515.

It will be understood that the example system 500 of FIG. 5 is just one example of uses of the apparatus 100 for emulating a wireless mesh network. For example, instead of USB connectivity, other implementations may use wired Ethernet or the like. Similarly, although an assembled arrangement of first and second further apparatus 200, 300 is depicted, other arrangements for conductively coupling one or more communications devices to the monopole antennas may be implemented.

In use, the communications devices 220 may be configured to operate with data transmission and reception corresponding to use as smart metering devices. As such, each monopole antenna 105 may be configured to emulate an antenna of a smart metering device.

The processors 505 may be configured to control the communications devices 220 such that a wireless mesh network is formed using the plurality of monopole antennas 105.

Operation of the wireless mesh network may be based on data fetched from the database 510. Data pertaining to operation of the wireless mesh network may be stored by the database 510.

As described above, the system 500 of FIG. 5 comprises a plurality of apparatuses 100. Each apparatus may be disposed immediately adjacent another apparatus 100 of the plurality of apparatuses. In some examples, a ground plane of an apparatus 100 may be conductively coupled to a ground plane of one or more immediately adjacent apparatuses 100.

The plurality of apparatuses 100 may be used to emulate different wireless mesh network fringe shapes, by placing each apparatus 100 relative to each other apparatus in a configuration providing, at least approximately, a desired fringe shape.

This is described further below with reference to FIGS. 11a and 11b.

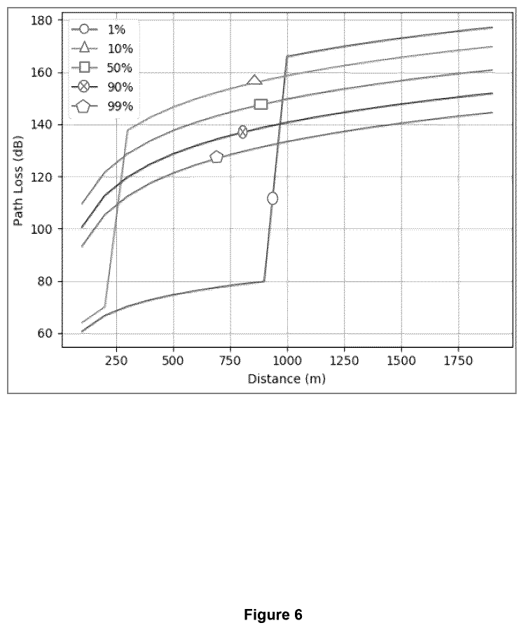

Design of the apparatus 100, wherein each monopole antenna is disposed within a near-field region of a neighboring monopole antenna when the monopole antennas are used to emulate a wireless mesh network operating within a desired communications frequency range, is now described with reference to FIGS. 6 to 10.

FIG. 6 is a graph of a propagation model depicting probabilities of transmission path losses versus distance based on a Site General Model in an urban environment. This graph is based on the International Telecommunications Union (ITU), Recommendation P.1411-11 (09/2021).

The propagation model described by the graph may be considered representative of an RF smart metering application, because it is based in a similar environment, e.g. urban, and is based on similar frequencies of communication, e.g. 400 MHz.

As an example, the graph shows that 99% of transmissions at 400 MHz will incur a path loss of approximately 135 dB at a distance of 1000 metres in an urban environment.

The data in the graph of FIG. 6 provides a general reference for converting distance, in meters, to a likely path loss, in dB. As such, the propagation model of FIG. 6 can be used to develop a model of a number of metering devices in a geographic uniform distribution against an expected path loss.

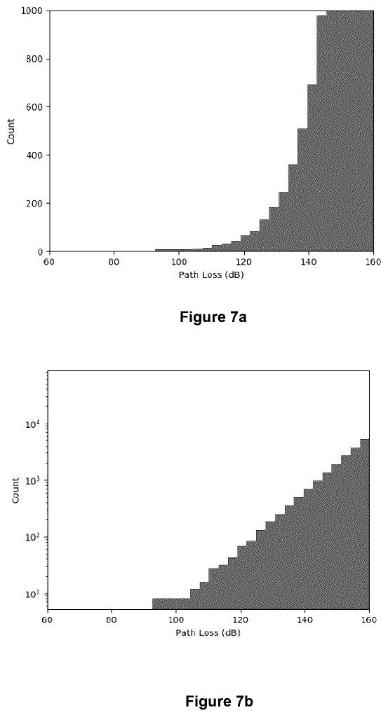

FIGS. 7a and 7b depict such a model of a number of metering devices in a geographic uniform distribution against an expected path loss, based on the 90% probability curve of the graph of FIG. 6. It is assumed that metering devices are separated from one another by 20 meters and employing an RF communications frequency of 915 MHz.

As an example, FIG. 7a shows that, as a number of devices approaches 600, a path loss would be in the region of 140 dB. FIG. 7b represents the exponential data of FIG. 7b on a logarithmic scale.

From FIG. 7b, it can be seen that a range of interest of path losses is between approximately 90 dB and 160 dB with as many as 1000 devices. This may be considered to be representative of a real-life scenario, wherein approximately 1000 devices separated from each other by 20 meters and operating at 915 MHz would see path losses ranging from between 90 and 160 db.

Having established the model of FIGS. 7a and 7b, it may then desirable to adapt the apparatus 100 to accurately emulate such a model. That is, an apparatus 100 having approximately 1000 monopole antennas may be designed to emulate the path loss range of the models of FIGS. 7a and 7b, and thereby may be suitable for emulating a deployment of approximately 1000 metering devices in an urban environment.

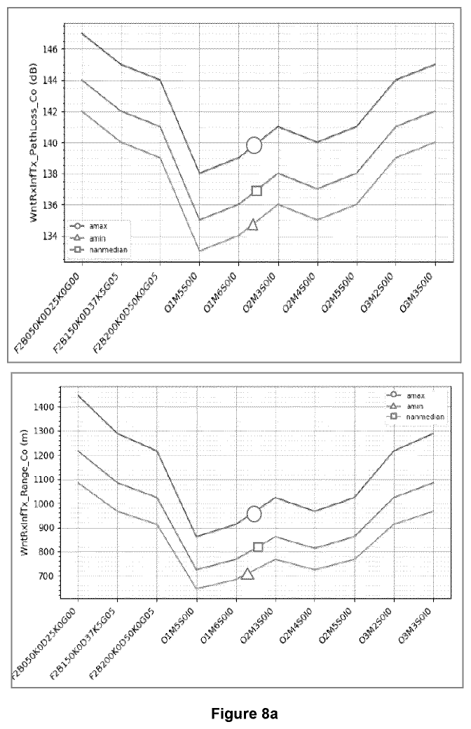

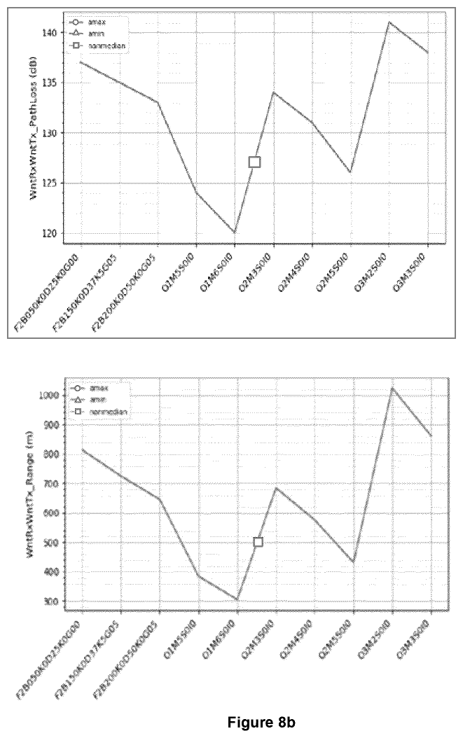

FIG. 8a depicts interference ranges for a selection of PHY modes supported in a “Wireless Smart Ubiquitous Network (Wi-SUN) 1.1 network”. Interference ranges are depicted both in terms of losses in dB and equivalent ranges based on the propagation model of FIG. 6.

Different modes of communication are denoted on the x-axis. For example, “F2B050, F2B150, F2B200” corresponds to 2FSK modulation at 50 kb/s, 150 kb/s and 200 kb/s respectively. “01M5, O1M6, O2M3, etc.” corresponds to OFDM modulation at 1.5 Mbit/s, 1.6 Mbit/s and 2.3 Mbit/s respectively.

The interference range models of FIGS. 8a show that a maximum path loss is approximately 147 dB, which based on the propagation model of FIG. 6 corresponds to a distance of approximately 1400 meters. A minimum range for interference is approximately 133 dB.

Similarly, FIG. 8b depicts communications ranges for the same selection of PHY modes supported in a Wi-SUN 1.1 network. It can be seen that the range of path loss to enable communications between devices is between 120 dB and 140 dB, which based on the propagation model of FIG. 6 corresponds to distances of between approximately 300 meters and 1000 meters.

Thus, based on application of the propagation model to the interference range and communication range data of the selection of PHY modes supported in a Wi-SUN 1.1 network, it can be seen that it is desirable for the apparatus 100 to be suitable for emulating a path loss range of approximately 100 db to 150 db, thereby covering the full communications and interference ranges depicted in FIGS. 8a and 8b.

That is, FIGS. 7a and 7b depict a desired shape of a response, e.g. exponential relationship between path loss increase and a number of metering devices, and FIGS. 8a and 8b provide a desired range of between 100 bd and 150 dB. Based on these targets, the apparatus 100 may be adapted accordingly, such that with an array of monopole antennas each within a near field range of a neighboring monopole antenna, energy can be distributed to the monopole antennas through the air in a manner that emulates the far field.

The following example apparatuses 100 are provided with specific dimensions for purposes of non-liming example only.

In first example, an apparatus for emulating a wireless mesh network may be provided with a 2-D array of approximately quarter-wave monopole antenna, wherein each monopole antenna is within a near field of its neighboring monopole antenna. The example 27×18 array may have 486 monopole antennas, each of approximately 80 millimeters in length, and arranged on a 200 millimeters×300 millimeter ground plane as a 27×18 array, with a 10 millimeter separation between adjacent monopole antennas. This apparatus is depicted in FIG. 9a.

A resultant (simulated) path loss distribution at 915 MHz is depicted in FIG. 9b, which depicts a distribution of coupled energy from a center monopole antenna to all other monopole antennas. It can be seen that the distribution generally corresponds to the shapes of the distribution of FIG. 6, thereby validating the effectiveness of the apparatus for emulating a wireless mesh network. Notably, a drop-off in path loss towards higher counts of monopole antennas, e.g. further from the center monopole antenna, is due to RF signals approaching an edge of the apparatus where losses are reduced due to fewer monopole antennas in the near-field range.

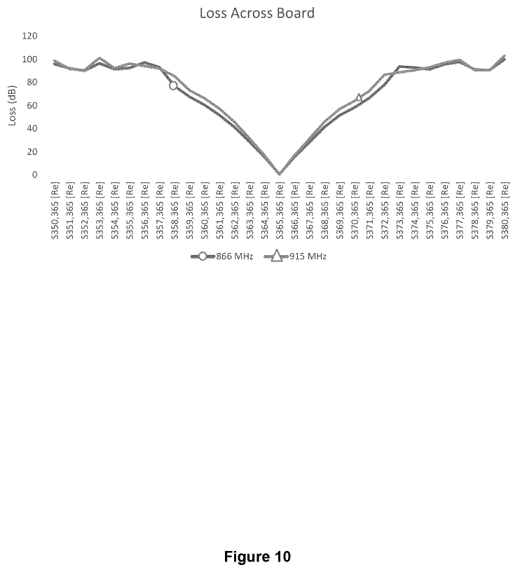

FIG. 10 depicts path losses across another example apparatus, this time having a 300×300 millimeter configuration. It can be seen that a path loss from a center device to an adjacent device is approximately 20 dB. It can also be seen that the path loss reaches a maximum of approximately 100 dB. As described above, an objective path loss may be in the region of 100 dB to 150 dB. As such, an attenuation may be added to the monopole antennas to offset the losses.

For example, an additional 45 dB of attenuation per monopole antenna would add 90 dB of path loss to a path between any two monopole antennas. Based on the example apparatus described by FIG. 10, this would results in path losses form a center monopole antenna of between 90 dB and 190 dB. Since, in practice, a metering device would be incapable of communication with path losses as high as 190 dB, this would mean operation as a network, e.g. a mesh network, would be necessary for one metering device to communicate with. Thus, it can be seen that the disclosed apparatus, with optional further attenuation between monopole antennas, may be particularly suitable for emulating a real-life wireless mesh network of smart meter devices spread over a large geographical area.

Several techniques may be applied, individually or in combination, to achieve desired path losses. For example, in some embodiment a spacing between antennas may be adjusted to adjust the path losses. In an example, a spacing between antennas may be reduced which may increase an effective path loss between antennas. In some examples, each monopole antenna may be disposed within a reactive near field region of one or more neighboring monopole antennas.

In other examples, a length of each monopole antenna may be adjusted to select a desired path loss between monopole antennas. For example, by reducing a length of the monopole antennas, an attenuation of RF signals between said monopole antennas in an apparatus for emulating a wireless mesh network may be increased. In other examples, an impedance may be coupled to each monopole antenna to select a desired path loss between monopole antennas. That is, a terminating impedance, which may comprise a resistor or the like, may be conductively coupled to each monopole antenna to increase an attenuation of signals transmitted between monopole antennas in an apparatus for emulating a wireless mesh network.

In other examples, and as depicted in FIG. 1, a dielectric material 120 may be disposed between and extending around each monopole antenna 105 to select a desired path loss between monopole antennas 105 in an apparatus for emulating a wireless mesh network.

FIG. 11a depicts an example of injecting a gateway signal into an apparatus 1100 for emulating a wireless mesh network, according to an embodiment of the disclosure.

Features of the apparatus 1100 generally corresponds to features of the apparatus 100 of FIG. 1a. That is, the apparatus 1100 comprises a plurality of monopole antennas 1105 arranged on a substrate 1115, and a plurality of connectors 1110 for conductively coupling the plurality of monopole antennas 1105 to at least one communications device. The apparatus 1100 also comprises a dielectric material 1120 disposed between and extending around each monopole antenna 1105.

The apparatus 110 also comprises a further monopole antenna 1165. The further monopole antenna 1165 may be coupled to a further communications device 1170. In an example, an SMA connector 1175 couples the further monopole antenna 1165 to the further communications device 1170.

The further monopole antenna 1165 is disposed substantially at a center of the array of monopole antennas 1105. In one example, an aperture may be formed in the dielectric material 1120 and the further monopole antenna 1105 is inserted into the aperture. In another example, the dielectric material 1120 may be formed around the further monopole antenna 1105, such as by a process of molding or encapsulation.

The further monopole antenna 1165 and the further communications device 1170 may be configured to operate as a gateway device or router, providing a means to communicate with and/or transfer data over a wireless mesh network emulated by the plurality of monopole antennas 1105.

In some examples, an attenuation of the further monopole antenna 1165 may be selected to emulate a pole-mounted device. That is, a power of transmission and/or sensitivity of reception of the further monopole antenna 1165 may be increased relative to the plurality of monopole antennas 1105, such that the further monopole antenna 1165 may emulate a pole-mounted gateway or router device.

In another example depicted in FIG. 11a, a central monopole antenna 1180 of the plurality of monopole antennas 1105 may be configured to function as the gateway or router device. For purposes of example only, a further communications device 1190 is coupled to the central monopole antenna 1180 via an SMA connector 1185

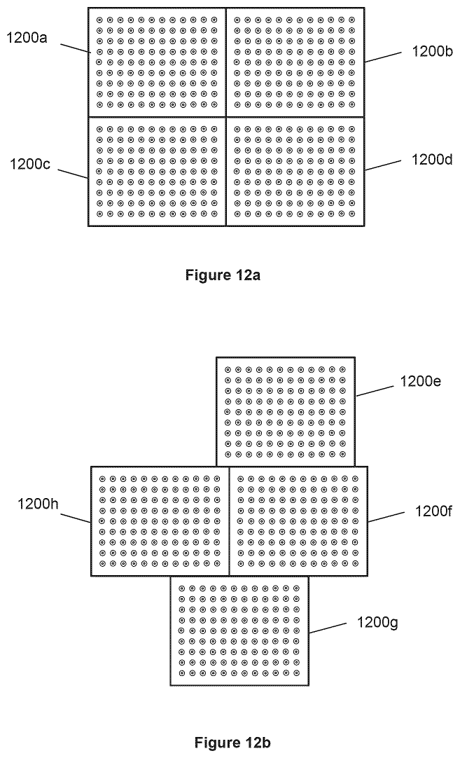

FIG. 12a depicts a first example arrangement comprising a plurality of apparatuses 1200a-d for emulating a wireless mesh network. Each apparatus may be, for example, any of the above-described apparatus, such as the apparatus of FIG. 1. By placing a plurality of apparatuses 1200a-d immediately adjacent one another as depicted in FIG. 12a, a larger distribution of metering device over a larger geographical area may be emulated. In some examples, a ground plane of each apparatus 1200a-d may be conductively coupled to a ground plane of at least one other o the apparatuses 1200a-d. Although only four apparatus 12a-d are depicted, it will be understood that fewer than four or greater than four apparatus may be implemented.

In use, different fringe shapes may be emulated by rearranging the apparatuses. As an example, FIG. 12b depicts a second example arrangement comprising a plurality of apparatuses 1200e-h for emulating a wireless mesh network. In this example, an irregular fringe shape may be formed by the arrangement of apparatuses 1200e-h.

Although the disclosure has been described in terms of particular embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

LIST OF REFERENCE NUMERALS

| | |
|---|---|
| 100 | apparatus |
| 100a | first alternative apparatus |
| 100b | second alternative apparatus |
| 105 | monopole antenna |
| 105a | monopole antenna |
| 105b | monopole antenna |
| 110 | connector |
| 115 | substrate |
| 115a | substrate |
| 115b | substrate |
| 120 | dielectric material |
| 200 | first further apparatus |
| 215 | substrate |
| 220 | communications device |
| 225 | power supply circuitry |
| 230 | additional control circuitry |
| 235 | end portion |
| 300 | second further apparatus |
| 310 | connectors |
| 315 | substrate |
| 350 | power supply connectors |
| 355 | USB driver circuitry |
| 360 | USB connector |
| 400 | system |
| 500 | system |
| 505 | processor |
| 510 | database |
| 515 | Ethernet connection |
| 520 | USB cable |
| 1100 | apparatus |
| 1105 | monopole antenna |
| 1110 | connector |
| 1115 | substrate |
| 1120 | dielectric material |
| 1165 | further monopole antenna |
| 1170 | further communications device |
| 1175 | SMA connector |
| 1180 | central monopole antenna |
| 1185 | SMA connector |
| 1190 | further communications device |
| 1200a-h | apparatus |

1. An apparatus for emulating a wireless mesh network, the apparatus comprising:
a plurality of monopole antennas; and
at least one connector for conductively coupling the plurality of monopole antennas to at least one communications device,
wherein each monopole antenna is disposed within a near-field region of a neighboring monopole antenna when the monopole antennas are used to emulate a wireless mesh network operating within a communications frequency range of 3500 MHz to 300 MHz.

2. The apparatus of claim 1, wherein the communications frequency range is from 1000 MHz to 400 MHz, and optionally wherein the communications frequency range is from 915 MHz to 860 MHz.

3. The apparatus of claim 1, wherein each monopole antenna comprises a length substantially corresponding to a length of a quarter-wave monopole for a frequency within the communications frequency range.

4. The apparatus of claim 1, wherein the near-field region is a reactive near field region.

5. The apparatus of claim 1, wherein:
the plurality of monopole antennas are arranged in an array, an offset grid and/or concentric patterns; and
the plurality of monopole antennas are arranged such that each monopole antenna extends longitudinally in a direction parallel to a direction in which a neighboring monopole antenna extends longitudinally.

6. The apparatus of claim 1, wherein, for a wireless signal within the communications frequency range, a path attenuation between a first monopole antenna disposed in a central region of the plurality of monopole antennas and a second monopole antenna of the plurality of monopole antennas is configured to be between 90 dB and 160 dB by selection of at least one of:
a length of each monopole antenna;
a spacing between each monopole antenna;
a magnitude of an impedance coupled to each monopole antenna; and/or
a dielectric material disposed between and extending around each monopole antenna.

7. The apparatus of claim 1, comprising a terminating impedance coupled to each monopole antenna.

8. The apparatus of claim 7, wherein the terminating impedance of at least one of the plurality of monopole antennas is different from, and/or variable relative to, the terminating impedance of at least one other of the plurality of monopole antennas.

9. The apparatus of claim 1, wherein:
the plurality of monopole antennas extend from a first side of a substrate;
and the at least one connector is provided on a second side of the substrate; and
the substrate comprises a ground plane.

10. The apparatus of claim 1, comprising a/the dielectric material disposed between and extending around each monopole antenna.

11. A system for emulating a wireless mesh network, the system comprising:
an apparatus according to claim 1; and
the at least one communications device conductively coupled to each monopole antenna by the at least one connector,
wherein the at least one communications device is configured to transmit and/or receive a wireless signal within the communications frequency range using each monopole antenna.

12. The system of claim 11, comprising a plurality of apparatuses, wherein each apparatus is disposed immediately adjacent another apparatus of the plurality of apparatuses.

13. The system of claim 11, wherein the at least one communications device comprises at least one modem.

14. The system of claim 11, comprising one or more processors configured to control the at least one communications device to emulate a wireless mesh network between the monopole antennas.

15. The system of claim 11, where a communications device, coupled to one of the monopole antennas is configured to operate as a gateway device.

16. A method of emulating a wireless mesh network, the method comprising:
conductively coupling a plurality of monopole antennas to at least one communications device, wherein each monopole antenna is disposed within a near-field region of a neighboring monopole antenna when the monopole antennas are used to emulate a wireless mesh network operating within a communications frequency range of 3500 MHz to 300 MHz; and
configuring the at least one communications device to form a wireless mesh network between the plurality of monopole antennas by transmitting and/or receiving signals within the communications frequency range.

17. The method of claim 16, comprising a step of configuring a communications device coupled to one of the monopole antennas to operate as a gateway device to the mesh network.

18. The method of claim 17, comprising a step of increasing a transmission power and/or reception sensitivity of the monopole antenna operating as a gateway device relative to the other monopole antennas of the plurality of monopole antennas.
